(19) United States
(12) Patent Application Publication
(10) Pub. No.: US 2009/0303051 A1
(43) Pub. Date: Dec. 10, 2009

(54) Wireless Monitor System for Body Temperature, Environment Temperature and Pulse

(76) Inventor: Ping-Leung LAM, Kwai Chung (HK)

Correspondence Address: Troxell Law Office Pllc, 5205 Leesburg Pike, Suite 1404, Falls Church, VA, 22041, US

(21) Appl. No.: 12/134,346

(22) Filed: Jun. 6, 2008

(51) Int. Cl. G08B 23/00

(52) U.S. Cl. 340/573.1

(57) ABSTRACT

A wireless monitor system for body temperature, environment temperature and pulse, especially an all-round supervising system with limits being configured depending on standards, includes primarily a receiver, a detecting device and a detecting piece. The detecting piece and the detecting device are located respectively at an underarm and an exterior side of clothes of a person under detection (such as a toddler, a handicapped person, an aged person or a patient), to supervise the environment temperature, body temperature and pulse. If a condition occurs, an alert is issued immediately with a warning unit, and the receiver is informed to notify a related person to come for treatment. The receiver itself is also provided with functions of a time design, data transmission and memorizing, allowing the monitor system to be used more conveniently and practicably.

### BACKGROUND OF THE INVENTION

a) Field of the Invention

The present invention relates to a wireless monitor system for body temperature, environment temperature and pulse, and more particularly to a detecting and informing system which supervises body temperature, environment temperature and pulse of a person under detection (such as a toddler, a handicapped person, an aged person or a patient).

b) Description of the Prior Art

There are lots of reasons causing sudden death of a toddler Although the reasons are complicated, the sudden death is mostly caused by negligence in taking care of the toddler. On the other hand, it is often heard and almost inevitable that the toddler will get a cold or flu as the toddler is not taken care of properly, in spite of not being dead. The reasons include:
1. Abnormality of air conditioning in environment. For example, due to insensitiveness or misadjustment in tuning the air conditioning, the toddler will be affected whether the air conditioning is too cold or too warm, and can be uncovered by kicking out a quilt, which may cause the toddler to get a cold or to be smothered or trapped by the quilt.
2. A sudden uncomfortable condition. For example, when an insultus of an inherently unmentionable disease or an action of spitting milk or turning a body occurs, as a critical window of survival at this time is shorter, a devastating consequence may happen to leave behind many regrets, if not paying attention.
3. A symptom that is ignored easily. For example, an initial period of fever is rarely discovered when the toddler is still energetic enough and is also wearing too much that he or she does not sweat easily. However, once over a sleep at a night, the fever has been reached to a climax; therefore, if the fever is not found in time, there can be an unknown danger, and this symptom is also ignored most easily.

Regarding to the aforementioned crises, in addition to visiting from time to time in hardship, ordinary parents or guardians (baby sitters or medical personnel) can only purchase a machine of a surveillance function (sound or image), which is separated into two units, with one unit being placed beside the toddler for watching or listening to his or her image or sound, and the other unit being placed beside an adult for watching or listening. Nevertheless, when the toddler is smothered by the quilt or is not able to sound, it cannot be aware of and thus the critical window of survival is lost. Furthermore, when a blurring phenomenon occurs due to a smaller screen or a single color of a monitoring screen, it is basically unable to clearly supervise the condition around the toddler. Therefore, some functions cannot be still achieved by that kind of product. Besides, it is quite normal that the toddler will make sound or swing his or her hands and legs; therefore, the adults will be mentally stressed without being able to sleep comfortably in using the aforementioned conventional product. This is caused by that this kind of product is not configured with safety indicators, which is a shortcoming of the conventional product.

As for body temperature, environment temperature and pulse, they can only be measured by persons who are equipped with some medical knowledge at any time, but only a random treatment can be conducted and there is no standard system to serve as a reference for configuration; therefore, an in time and effective protection to the safety of toddler is not available.

Moreover, as an existing society has been gradually marching toward aging, an aged person will usually need more cares, and a handicapped person and a patient will also need more cares because they cannot take care of living by themselves. However, only the monitor system is available in an ordinary market, and there is no supervising system that can measure pulse, body temperature and environment temperature when those people are sleeping or lying on hospital beds. Accordingly, they will get a cold from time to time or their original vulnerable bodies can be even harmed more, which are all the issues to be solved in the existing society.

### SUMMARY OF THE INVENTION

The primary object of the present invention is to provide an all-round detecting and informing system that can supervise environment temperature, body temperature and pulse of a person under detection (such as a toddler, a handicapped person, an aged person or a patient), including primarily a receiver, a detecting device and a detecting piece. The detecting piece and the detecting device are provided respectively at an underarm and on clothes of the person under detection, to supervise the environment temperature, the body temperature and the pulse. If any condition occurs, then an alert will be issued by a warning unit, and the receiver will be informed to notify a related person to come for treatment. In addition, the receiver itself is also provided with functions of a time design, data transmission and memorizing, allowing the system to be applied more conveniently and practicably.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of an entire system of the present invention.

FIG. 2 shows a system structural diagram of the present invention.

FIG. 3 shows a flow diagram of usage of the present invention

### DETAILED DESCRIPTION OF THE PREFERRED EMBODIMENTS

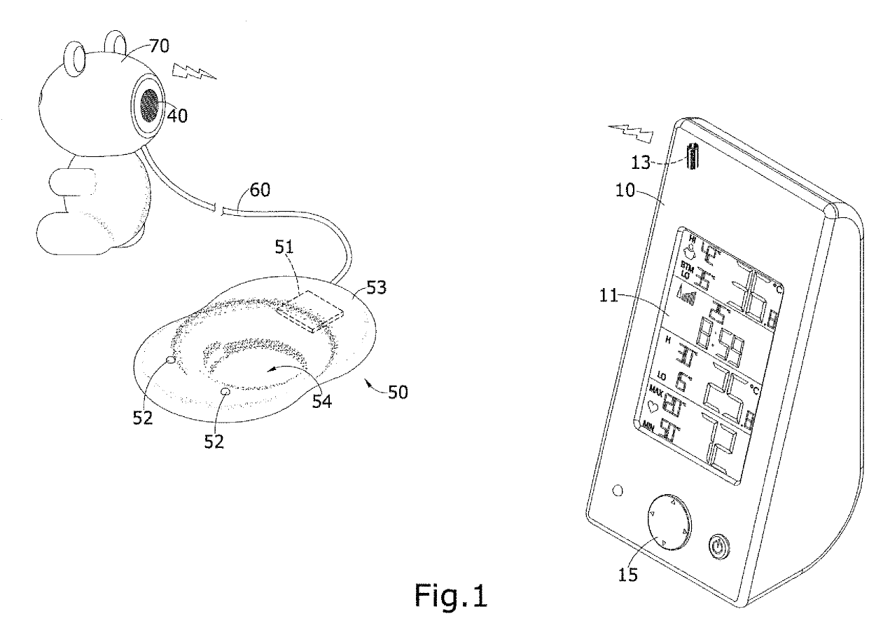

Referring to FIG. 1, the present invention comprises primarily a receiver 10, a detecting device 40 and a detecting piece 50.

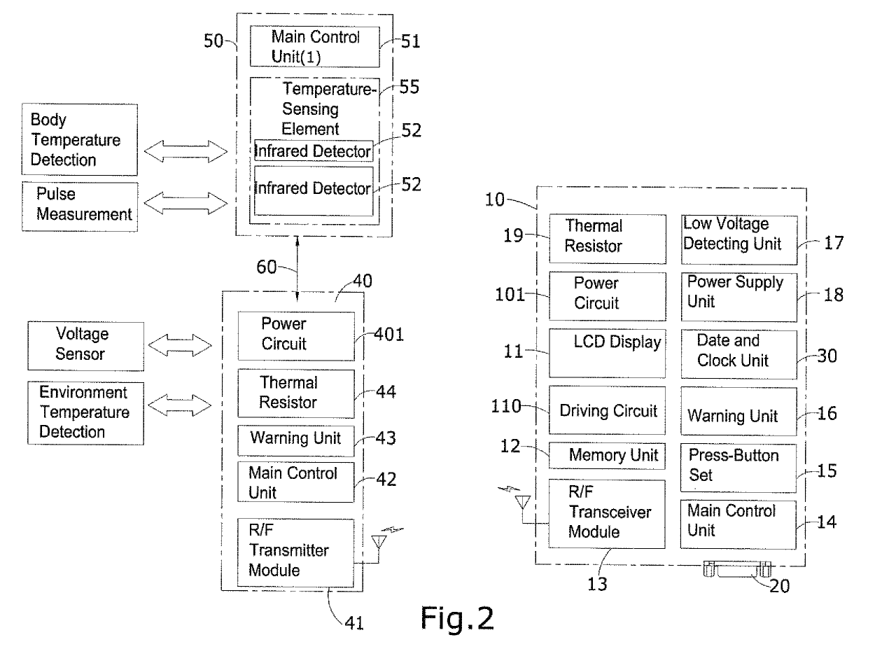

Referring to FIG. 1 and FIG. 2, an interior of the receiver 10 is provided with a power circuit 101, an LCD display 11, a driving circuit 110, an R/F transceiver module 13, a memory unit 12, a main control unit 14, a press-button set 15, a warning unit 16 and a thermal resistor 19, wherein the LCD display 11 is a function display screen of all units, can display data analyzed by the main control unit 14, and can also show information transmitted from the R/F transceiver module 13 to the detecting device 40 and the detecting piece 50. The information can be transmitted by the driving circuit 110 to the warning unit 16 and are displayed with warning light or warning sound, when reaching a standard of warning, after being determined by the main control unit 14. Whereas, the press-button set 15 can be used to configure some basic data and standards, and information configured or collected can be stored by the memory unit 12. On the other hand, the thermal resistor 19 is used to monitor the environment temperature.

A specification of the R/F transceiver module 13 can be a 00K/ASK super-heterodyne 315 MHz or 434 MHz, with its purpose for choosing a different frequency depending on regulations of different countries. As this belongs to an ordinary technology, an interior of the module is not described further.

On the other hand, depending on demands, the receiver 10 can be provided with a low voltage detecting unit 17 to provide a reference for power determination. The power can be constructed by a power supply unit 18 which is formed by batteries or an A/C current. In a mean time, the receiver 10 can be also provided with a connector set 20 to output some data which can be printed out from an external printer. Moreover, the receiver 10 can be further provided with a date and clock unit 30 to provide for an application of time.

The detecting piece 50 is a plate-body having a curved surface 54, a side of which is coated with a layer of conductive glue 53. The conductive glue 53 is a kind of nontoxic and anti-allergic medical glue and can be used repeatedly. An interior of the detecting piece 50 is embedded with a circuit of main control unit 51, and a temperature-sensing element 55 which includes two infrared detectors 52 for detecting the body temperature and pulse count, respectively. After being determined by the main control unit 51, the measured values are transmitted to the detecting device 40 through a connecting wire 60. On the other hand, if the detecting piece 50 can fit with the aforementioned structure and technology then its shape can be changed freely.

An interior of the detecting device 40 is provided respectively with a power circuit 401, an R/F transmitter module 41 (its specification is corresponding to the receiver), a main control unit 42, a thermal resistor 44 for measuring the environment temperature, and a warning unit 43. The data of detecting piece 50 transmitted from the connecting wire 60 is determined by the main control unit 42, is then transmitted to the receiver 10 from the R/F transmitter module 41 in one way, and in the other way, an alert can be issued with flash light and sound by the warning unit 43, if the data exceeds the standard value of body temperature, pulse count and environment temperature. An exterior side of the detecting device 40 can be fixed with a planar or three-dimensional shaped object 70 to soothe and comfort the toddler.

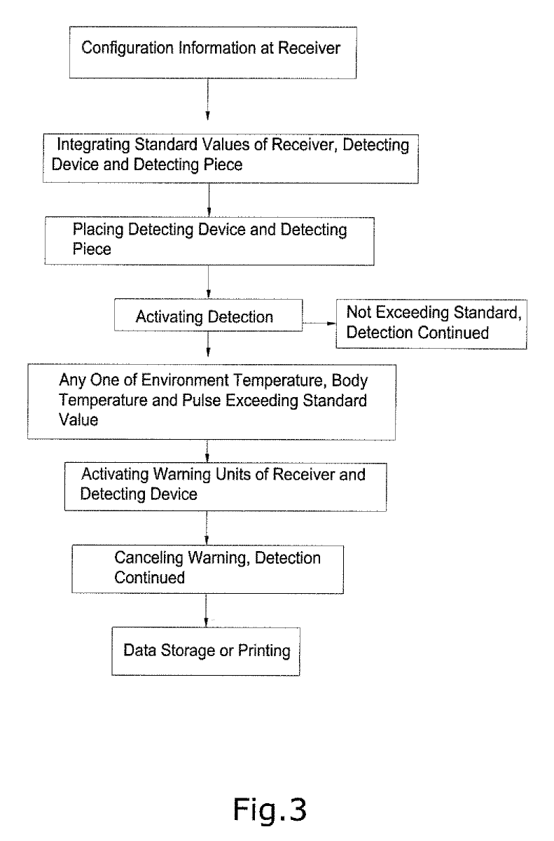

Referring to FIG. 3, it shows a flow diagram of usage of the present invention, in association with FIGS. 1 and 2. The flow comprises first configuring information at the receiver 10, such as the standard temperature (whether the environment temperature or the body temperature) of measurement, as well as an upper bound and a lower bound of the pulse; integrating the standard values of receiver 10, detecting device 40 and detecting piece 50, enabling the three values to be unified; placing the detecting device 40 and the detecting piece 50 at proper positions, such as placing the detecting piece 50 at the underarm of the person under detection, and fastening the detecting device 40 at an exterior side of clothes, inside a quilt or outside the quilt with a safety pin, depending on the position where the environment temperature is measured; and then activating the detection. If the standard value is not exceeded, then the detection continues. On the other hand, if any one of the environment temperature, body temperature or pulse exceeds the standard value, then the warning units 16, 43 of the receiver 10 and detecting device 40 will be activated, alerting the related person to come for treatment immediately, with sound or flash light. The warning units 16, 43 can be configured that the warning action can be only stopped by canceling, and is configured that the condition of canceling the warning to continue detection is resumed by pressing any button of the press-button set 15. As for storing or printing the measured data, the data can be stored by the memory unit 12, and is outputted by the connector set 20 to be printed from an external printer. In addition, matching and application of time can be provided by the date and clock is unit 30.

In using the present invention, following functions can be achieved:
1. The present invention is the multiple safety system which integrates the environment temperature, the body temperature and the pulse count, wherein insufficiencies of conventional listen-in system and monitor system are replaced by the more realistic standards of supervising to the magnitude of temperature (body temperature and environment temperature) and the pulse count, such that when any measured value exceeds the standard, a supervising person can be informed immediately to take care of the person under detection (such as the toddler, handicapped person, aged person or patient)
2. The present invention is provided with the memory unit and the printing and outputting connector, such that the measured values can be recorded and can be linked with an office machine (computer and printer) at a same time, allowing the data to be accessed and recorded easily, which is another advantage of the present invention.
3. As the receiver of the present invention can be also configured with other functions, such as setting the time and date (for feeding or visiting at a fixed time), printing the measured data and measuring the voltage, such that the present invention can be used more conveniently and quickly with the powerful functions, which is still another advantage of the present invention
4. In terms of functions, one receiver can be associated with a plurality of detecting devices and detecting pieces at a same time, so as to supervise physiological conditions of plural persons under detection concurrently for safety, which is rather convenient and practical in usage.

Accordingly, the present invention can augment the care to the toddlers, and can benefit a lot to the handicapped persons, aged persons and patients; therefore, it is indeed provided with a value of business utilization and is not disclosed by other similar structures that have been published.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A wireless monitor system for body temperature, environment temperature and pulse, comprising at least a receiver, an interior of which is provided respectively with a power circuit, an LCD display, a driving circuit, an R/F transceiver module, a memory unit, a main control unit, a press-button set and a warning unit, with the LCD display being a function display screen for all units to display data analyzed by the main control unit and data transmitted from the R/F transceiver module to a detecting device and a detecting piece, with the data being transmitted by the driving circuit to the warning unit for alerting with warning light or warning sound, when the data reaching a standard of warning after being determined by the main control unit, and with the press-button set being used to configure some basic data and standards, whereas information configured or collected being stored by the memory unit; the detecting piece, which is a plate-body having a curved surface, a side of which is coated with a layer of conductive glue, and an interior of which is embedded with a circuit of main control unit, and a temperature-sensing element (thermal resistor and infrared detector), with the infrared detector being used to detect body temperature and a pulse count that are transmitted to the detecting device through a connecting wire after being determined by the main control unit; and the detecting device, an interior of which is provided respectively with a power circuit, an R/F transmitter module, a main control unit, a thermal resistor and a warning unit, when the data of detecting piece that is transmitted through the connecting wire being determined by the main control unit, in one way being transmitted to the receiver from the R/F transmitter module, and in the other way, the warning unit issuing an alert with flash light or sound, when the data exceeding the standard value of environment temperature, body temperature and pulse count.

2. The wireless monitor system for body temperature, environment temperature and pulse, according to claim 1, wherein the receiver is provided with a low voltage detection unit on demands.

3. The wireless monitor system for body temperature, environment temperature and pulse, according to claim 1, wherein power of the receiver is constructed by a power supply unit which is formed by batteries or an A/C current.

4. The wireless monitor system for body temperature, environment temperature and pulse, according to claim 1, wherein the receiver is provided with a connector set for outputting the data.

5. The wireless monitor system for body temperature, environment temperature and pulse, according to claim 1, wherein the receiver is provided with a date and clock unit.

6. The wireless monitor system for body temperature, environment temperature and pulse, according to claim 1, wherein there are two infrared detectors.

7. The wireless monitor system for body temperature, environment temperature and pulse, according to claim 1, wherein an exterior side of the detecting device is fixed with a planar or three-dimensional shaped object.

8. The wireless monitor system for body temperature, environment temperature and pulse, according to claim 1, wherein an interior of the receiver is provided with a thermal resistor for detecting the environment temperature.
